(19) United States
(12) Patent Application Publication
(10) Pub. No.: US 2015/0130265 A1
(43) Pub. Date: May 14, 2015

(54) Solenoid Valve Having Hydraulic Damping Mechanism

(71) Applicant: Kelsey-Hayes Company, Livonia, MI (US)

(72) Inventor: Leon Leventhal, Canton, MI (US)

(73) Assignee: KELSEY-HAYES COMPANY, Livonia, MI (US)

(21) Appl. No.: 14/078,023

(22) Filed: Nov. 12, 2013

(51) Int. Cl. F16K 31/06; B60T 13/18; B60T 13/16

(52) U.S. Cl. CPC F16K 31/0696; B60T 13/16; B60T 13/18
USPC 303/10; 251/48; 251/129.15

(57) ABSTRACT

A solenoid valve for fluid control of a vehicular hydraulic braking system includes an armature having a damping port. The damping port of the armature provides a turbulent fluid flow characteristic to fluid passing through the armature that creates a damping characteristic to attenuate noise and vibrational disturbances that is generally less sensitive to temperature and viscosity conditions of the fluid.

### BACKGROUND OF THE INVENTION

This invention relates in general to solenoid valves and, in particular, to solenoid valves for controlling hydraulic fluid flow in a vehicular braking system.

Solenoid valves are, generally, electromagnetically actuated valves that regulate hydraulic fluid flow in an automotive braking system, such as anti-lock braking systems (ABS), in response to sensor and driver inputs. The speed and reaction time of the valves impacts the performance of the braking system, particularly at low pressures and at low speed operation. These conditions are prevalent, particularly in traction control (TC), adaptive cruise control (ACC), and hill decent control (HDC) systems that rely on braking, in part, to maintain a set vehicle speed in response to varying vehicle power inputs.

As the actuation times of the solenoid valves increases, reaction forces within the valves create disturbances which may affect valve response and noise, vibration, and harshness (NVH) characteristics of the braking system. The NVH responses may produce an audible noise, such as valve clicking, which result in customer dissatisfaction and a perception of inferior system performance. It would be desirable to provide a solenoid valve having a mechanism to dampen or otherwise attenuate undesirable internal resultant forces, movements, acoustical responses and other NVH disturbances that occur within a solenoid valve.

### SUMMARY OF THE INVENTION

This invention relates to a solenoid valve that is configured for integration into a hydraulic system, such as a motor vehicle hydraulic system. In one embodiment, the solenoid valve may be configured as having a valve body, a tappet, and an armature. The valve body includes a bore and the tappet is disposed in the bore and configured to be axially displaceable relative to the bore. The armature is connected to the tappet and configured to selectively axially displace the tappet. The armature has at least one damping port that is configured to create a turbulent fluid flow characteristic of a fluid, within the valve body, during axial displacement of the armature and tappet. The turbulent fluid flow characteristic provides a damping characteristic that attenuates a vibration component of the tappet. In another embodiment, the solenoid valve may be configured such that the at least one damping port extends along an end bore of the armature. The damping port is defined by a flow groove depth, a flow diameter and an effective length that cooperate to create the turbulent flow characteristic. In another embodiment of the solenoid valve, the armature includes an actuating ball that connects the armature to the tappet. In yet another embodiment, the damping port is defined by a ratio of the flow groove depth to the flow diameter in a range of about 35 percent to about 40 percent and the effective length of the damping port defined by the actuating ball.

In another embodiment of the invention, a solenoid valve includes valve body having a sleeve connected to an outer portion of the valve body. A tappet is at least partially disposed in the valve body and in a bore of an armature. The armature further has an outer surface the is configured to cooperate with the sleeve to provide a restriction to fluid flow that is greater than a flow of fluid through the armature bore. In another embodiment, the valve body includes a bore that has a spring seat, and the tappet has a tappet shoulder. A spring is disposed between the spring seat and the tappet shoulder and generates a spring force in a first direction. The armature generates an actuating force in a second direction. In response to the actuating and spring forces, the tappet motion is a generally axial motion and the damping characteristic is responsive to the axial motion of the tappet. In another embodiment, the armature includes at least one damping port that is configured to cause the fluid flow through the armature to have a turbulent fluid flow characteristic through the at least one damping port. In other embodiments, the damping port has a flow groove depth and a flow diameter configured such that a ratio of the flow groove depth to flow diameter is in a range of about 30 percent to about 50 percent. In other embodiments, the armature of the solenoid valve includes an actuating ball and the damping port cooperates with the actuating ball to define an effective passage length that is generally tangent to the actuating ball. In certain aspects of this embodiment, the effective passage length is in a range of about 15 percent to about 30 percent of a diameter of the actuating ball. In another embodiment, the flow groove depth, the flow diameter and the effective length of the at least one damping port are sized to produce the turbulent flow characteristic from a fluid having a viscosity range of about 800-1200 centistokes and flowing with a pressure and flow rate in a range of about 100-800 bar and about 50-300 cc/s respectively.

In another embodiment of the invention, a vehicular hydraulic braking system includes a hydraulic control unit (HCU). The HCU includes a solenoid valve to control the flow of fluid through a conduit system. The solenoid valve includes a valve body, a sleeve connected to the valve body, and a tappet at least partially disposed in the valve body. The solenoid valve further includes an armature having a bore and an outer surface. A portion of the tappet is disposed in the armature bore. The armature bore is sized to permit fluid flow through the armature, and an outer surface of the armature provides a greater fluid flow restriction than fluid flow through the armature bore.

Various aspects of this invention will become apparent to those skilled in the art from the following detailed description of the preferred embodiment, when read in light of the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration of an embodiment of a vehicular hydraulic braking system including a hydraulic control unit.

FIG. 2 is a schematic illustration of an embodiment of the hydraulic control unit of FIG. 1 including a dampened solenoid valve assembly.

FIG. 3 is an enlarged, cross sectional view of the dampened solenoid valve of FIG. 2, having an embodiment of an armature.

FIG. 4A is an enlarged, perspective view of an embodiment of the armature of FIG. 3.

FIG. 4B is a cross sectional view of the armature of FIG. 4A taken along line 4B.

FIG. 4C is a cross sectional view of the armature of FIG. 4A taken along line 4C.

FIG. 4D is an enlarged view of the center portion of the armature of FIG. 4B.

FIG. 5A is an enlarged, perspective view of a prior art armature.

FIG. 5B is a cross sectional view of the armature of FIG. 5A taken along line 5B.

FIG. 5C is a cross sectional view of the armature of FIG. 5A taken along line 5C.

FIG. 6A is a performance plot of frequency versus amplitude at a zero ampere solenoid control current level of a prior art solenoid valve.

FIG. 6B is a performance plot of frequency versus amplitude at a 0.4 ampere solenoid control current level of the prior art solenoid valve.

FIG. 6C is the full series of performance plots of frequency versus amplitude at various solenoid control current levels of the prior art solenoid valve.

FIG. 7A is a performance plot of frequency versus amplitude at a zero ampere solenoid control current level of the solenoid valve of FIG. 3.

FIG. 7B is a performance plot of frequency versus amplitude at a 0.4 ampere solenoid control current level of the solenoid valve of FIG. 3.

FIG. 7C is the full series of performance plots of frequency versus amplitude at various solenoid control current levels of the solenoid valve of FIG. 3.

FIG. 8 is a comparative plot of flow versus pressure for the prior art valve and four embodiments of a dampened solenoid valve, similar to the solenoid valve of FIG. 3.

FIG. 9A is a performance plot of flow versus pressure for the prior art solenoid valve of FIG. 6C at the same solenoid current control levels.

FIG. 9B is a performance plot of flow versus pressure for the dampened solenoid valve of FIG. 7C at the same solenoid current control levels.

FIG. 10 is a comparative graph of acceleration measurements of valve clicking for prior art solenoid valve samples and dampened solenoid valves according to the invention.

### DETAILED DESCRIPTION OF THE PREFERRED EMBODIMENT

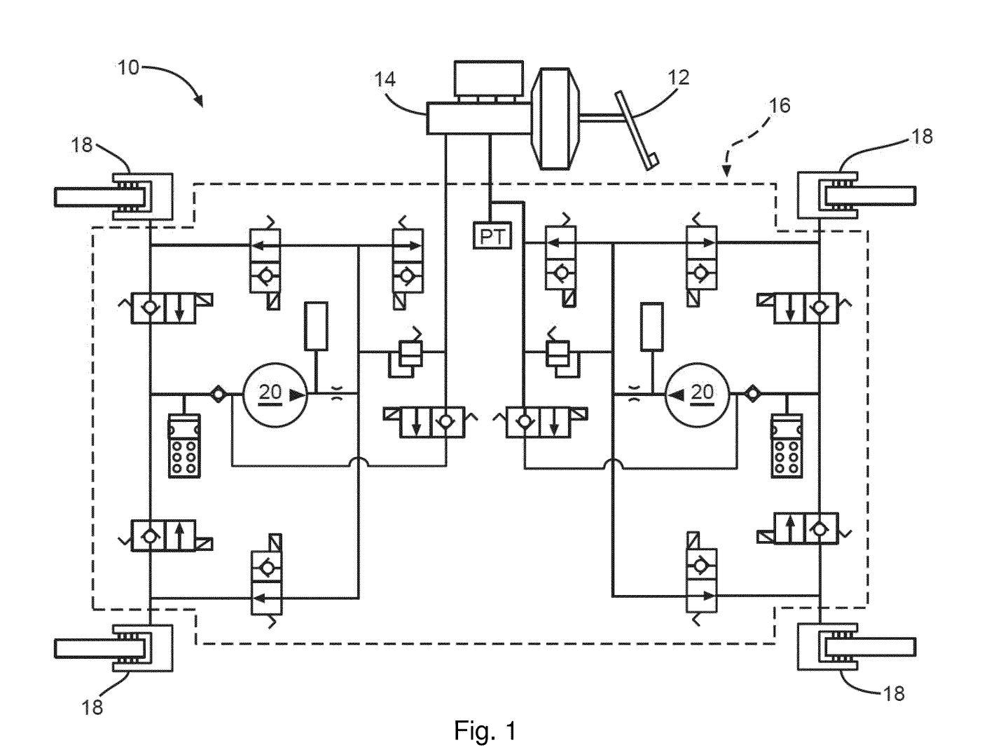

Referring now to the drawings, there is schematically illustrated in FIG. 1 a vehicular brake system, shown generally at 10. The vehicular brake system 10 includes a brake pedal 12 connected to a master cylinder 14. The brake pedal 12 and master cylinder 14 are a driver-controlled first pressure generation unit. A second pressure generation unit is illustrated as a hydraulic circuit, configured as a hydraulic control unit (HCU) shown generally at 16. The HCU 16 provides fluid communication between the master cylinder 14 and a plurality of wheel brakes 18. The wheel brakes 18 are shown as disc brakes but may be any type of wheel brake. The illustrated HCU 16 includes two hydraulic pumps 20, though any suitable number of pumps may be used. The pump 20 forms an autonomous second pressure generating unit that pressurizes and transfers fluid between the master cylinder 14 and the wheel brakes 18. The HCU 16 includes valves, such as solenoid valves, that will be described below in detail. The solenoid valves are responsive to input signals in order to control the flow of pressurized brake fluid to provide, for example, anti-lock braking, traction control, vehicle stability control, adaptive cruise control, hill decent control, and dynamic rear brake proportioning functions. It should be understood that the HCU 16 may be configured other than as depicted and may include additional, fewer, or different components. The various components of the HCU 16 may also be configured in different fluid communication arrangements depending on the specified performance requirements and/or functions provided by the designated vehicular brake system.

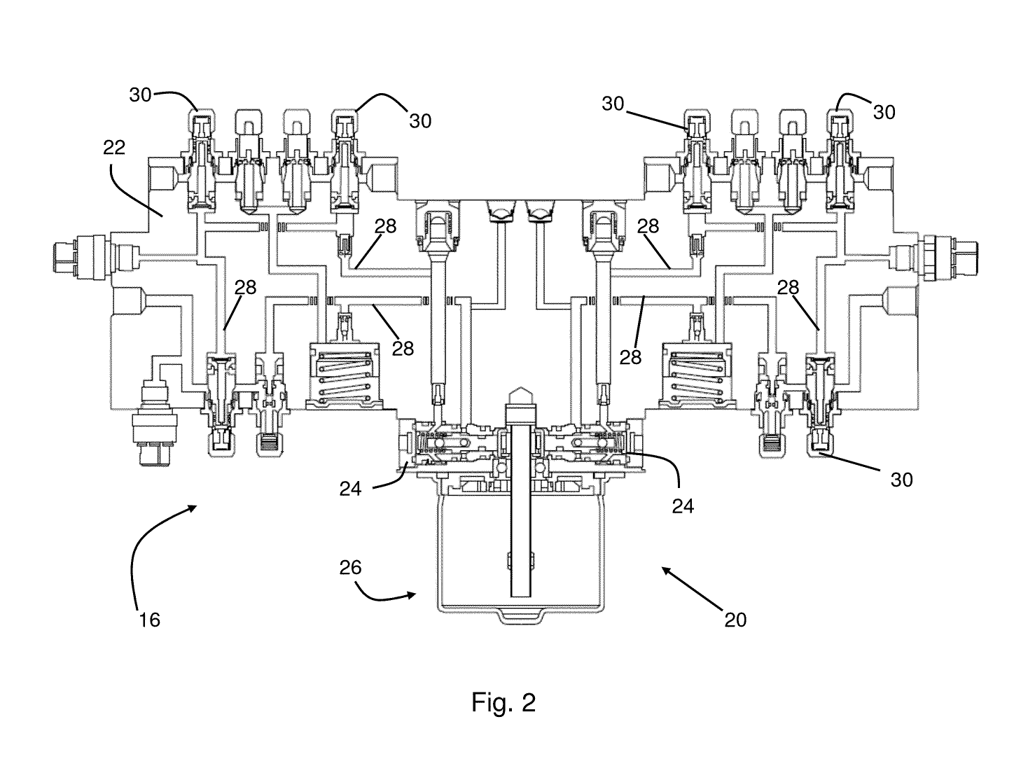

Referring now to FIG. 2, the HCU 16 is illustrated as the fluid circuit of FIG. 1, generally, that is contained in a valve housing 22. The pumps 20 are illustrated as two reciprocating piston pumps 24, though any number of pistons or any other type of hydraulic pump may be used. The piston pumps 24 are driven by a power source, such as an electric motor, which is illustrated as a variable speed motor 26. It should be understood that other configurations of pumps and motors are also considered within the scope of the invention. The HCU 16 supplies pressurized fluid to the brakes 18 through a fluid conduit system 28 and a valve arrangement that includes solenoid valves 30.

In operation of the vehicular brake system 10, brake fluid pressure may be initially created by the driver-controlled first pressure generating unit in response to a driving event. In other operating environments, brake pressure may not be initially created by the driver. Based on sensor inputs such as, for example, differential wheel speeds, steering angle, accelerometer measurements, the HCU 16 may modulate the fluid pressure to the wheel brakes 18 according to the brake function protocol required of the vehicle's operating condition and the requested function (i.e., anti-lock braking, traction control, vehicle stability control, adaptive cruise control, hill decent control, and dynamic rear brake proportioning, and the like).

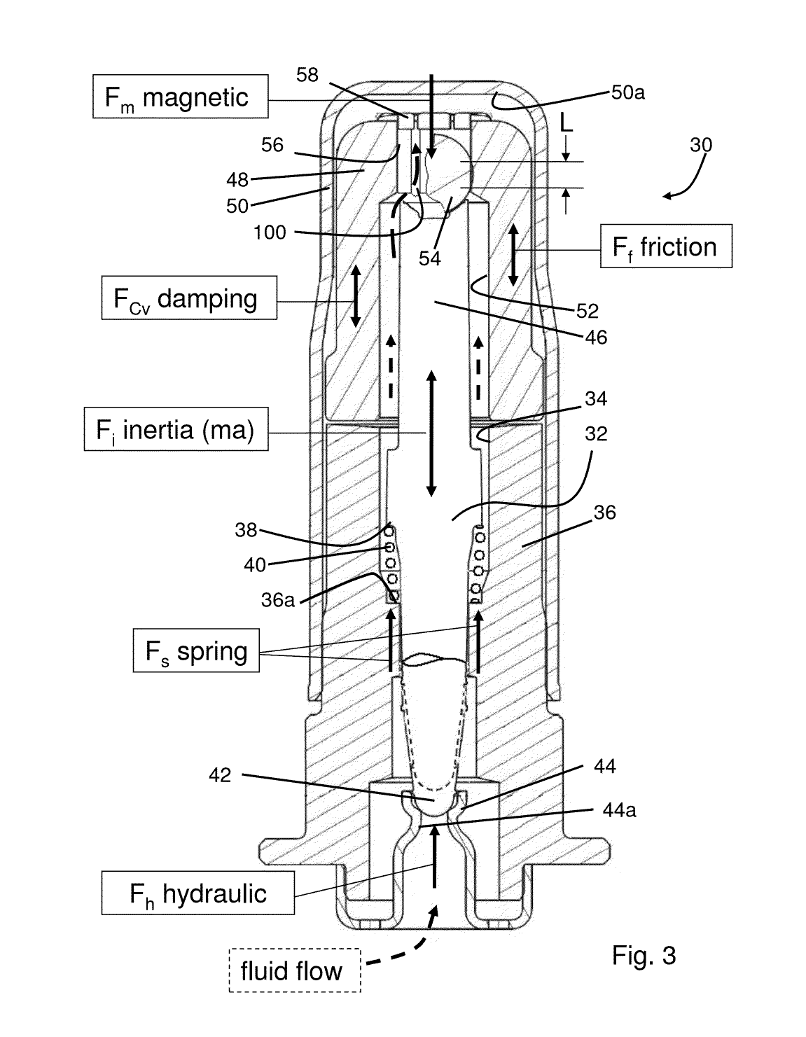

Referring now to FIG. 3, the solenoid valve 30, according to the invention, are shown in cross-section. FIG. 3 also shows an example of a generalized flow of fluid for at least one portion of an operating sequence of the valve and the forces acting on and influencing operation of the solenoid valve 30. The illustrated embodiment shows the solenoid valve 30 configured as a normally open valve, where the valve admits fluid flow in a power-off state. It should be understood that the invention described herein is applicable to and may be practiced with solenoid valves that are configured as normally closed (held closed in a power-off state) or floating (power required to actuate the valve to an open state or a closed state). Additionally, the flow of fluid depicted in FIG. 3 is illustrative only, and it should be understood that fluid flow may be in an opposite direction or in both directions, depending on the system configuration. The solenoid valve 30 includes a tappet 32 disposed in a bore 34 of a valve body 36. The valve body 36 includes a spring seat 36a, located at the end of the bore 34, that cooperates with a shoulder 38 on the tappet to trap a spring 40 therebetween. The tappet 32 further includes a nose 42 that extends through the bore 34 to contact a valve seat 44 having an inlet port 44a in order to control the flow of fluid. The tappet nose 42 is held in an open position (nose 42 shown as dashed lines) by the spring 36 bearing against the spring seat 36a and the tappet shoulder 38. The tappet 32 includes an actuator stem 46, positioned opposite the tappet nose 42, and connected to an armature 48. The armature 48 is disposed within a housing or sleeve 50 that is fixed to the valve body 36, and the armature 48 is free to move axially within the sleeve 50. The armature 48 is formed from a magnetic material that responds against magnetic flux produced by an electromagnetic coil (not shown) that is disposed around the sleeve 50. The armature 48 and tappet 32 move axially in response to forces created by the spring 36, the magnetic flux, and hydraulic fluid pressure.

In the illustrated embodiment, the tappet stem 46 extends into a bore 52 within the armature 48. An actuating ball 54 is fixed within an end bore 56 of the armature 48. Around the outer periphery of the end bore 56 is a stop ring 58, having a smaller diameter than the actuating ball 54 to retain the ball 54 within the end bore 56. The stop ring 58 includes a plurality of reliefs 60 that permits fluid movement between the armature 48 and the closed end of the sleeve 50 at the top of travel. Though shown as two separate components, the tappet 32 and the actuating ball 54 may be integrated as a single component. The actuating ball 54 bears against the end of the stem 46 and forces the tappet 32 into the closed position as the armature is moved toward the valve seat 44 by the magnetic flux of the coil. When the coil is deactivated, the spring 40 expands to move the tappet 32 and armature 48 to the open position. The armature 48 moves up against a closed end 50a of the sleeve 50. In the open position, fluid flows through the conduit 28 and to the solenoid valve, which permits fluid to flow through the valve seat 44 and continue flowing through the conduit 30. Additionally, there is a flow of pressurized fluid, shown by dashed arrows, that moves through the inlet 44a, past the tappet 32, through a space formed between the armature 48 and the valve body 36, and into the armature bore 52.

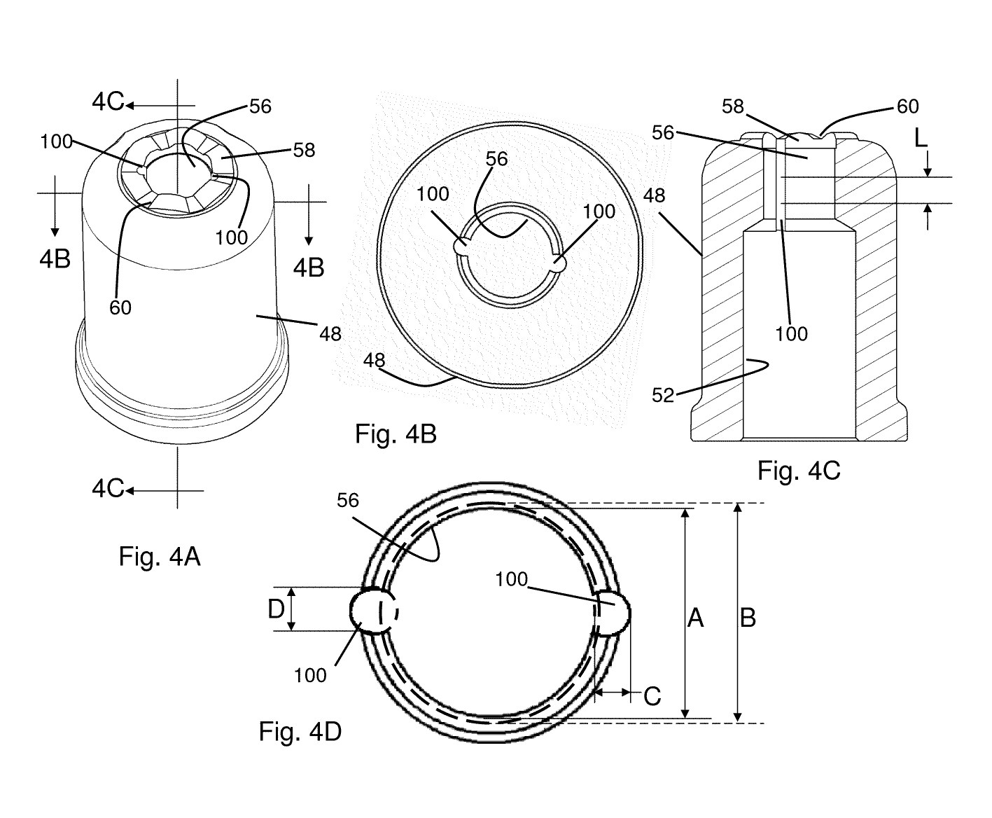

As shown in FIGS. 3 and 4A-4D, the armature 48 includes at least one damping port 100. The damping port 100 is shown as being formed in the peripheral wall of the end bore 56. In one embodiment, the damping ports 100 are positioned in line with at least one of the reliefs 60 of the stop ring 58, though such is not required. The damping port 100 provides a controlled flow path of pressurized fluid exiting the armature 48. In the illustrated embodiment, the damping ports 100 permit fluid flow past the actuating ball 54. The controlled fluid flow creates a turbulent flow characteristic having the advantage of dissipating energy that creates NVH issues such as tappet click, as will be explained below. As shown in FIG. 3, in one embodiment of the operating sequence, fluid flows up into the armature bore 52 and flows through the damping ports 100. The damping ports 100 are positioned and sized to cause fluid turbulence as the fluid flows and shears through a generally small and short flow path. The damping ports 100 may have any geometry, such as round, oval, hexagon, square, etc. Though shown as partial circles, the damping ports 100 may be complete bores, such as circular bores, that are not formed into the peripheral wall of the end bore 56. In one embodiment, the armature bore 52 may be increased in diameter by about 30%-40% to reduce mass and provide a larger fluid cavity to supply fluid to the damping ports 100. The larger diameter of the armature bore 52 also serves to increase the pressure differential across a shorter distance at the damping ports 100 to increase turbulent fluid flow activity through the ports 100.

As shown in FIG. 4D, the armature 48 includes the stop ring diameter, A and the end bore diameter, B, which is the same or slightly larger than the diameter of the ball 54. The stop ring diameter, A is smaller than the ball diameter, B due to the retention feature that secures the ball 54. For example, the stop ring 58 may be upset, staked or peened over the ball 54 to prevent the ball from exiting the armature 48. In another example, the smaller diameter of the end bore 56 may be formed or otherwise machined into the armature 48, and the ball 54 loosely trapped between the end bore 54 and the tappet actuator stem 46. There may be a diametral clearance between the ball and the bore diameter of the armature 48. The diametral clearance between the ball diameter and the larger diameter portion of the end bore may be on the order of 2-4% of the larger diameter portion of the end bore. In one embodiment, the clearance may be in a range of about 0.05 mm to 0.15 mm. A flow groove depth, C and a flow diameter, D of the damping port 100 are sized to provide the turbulent flow characteristic for a fluid having a viscosity range of about 800-1200 centistokes (cSt) and flowing with a pressure and flow rate in a range of about 100-800 bar and about 50-300 cc/s. In a specific embodiment, the flow groove depth, C and flow diameter, D of the damping port 100 are sized to provide the turbulent flow characteristic for a fluid viscosity of about 1000 centistokes (cSt) and flowing with about 400 bar pressure and at a flow rate of about 400 bar and about 130 cc/s. In one embodiment, a target ratio of flow groove depth, C to flow diameter, D (C/D) is about 40%. In another embodiment, the ratio C/D is in a range of about 30% to about 50%, and in yet another embodiment, the range may be about 35% to about 45%. The size of the flow groove depth, C and flow diameter, D of the damping port 100 and the minimal length of the resultant passage provide the basis for the turbulent flow characteristic and damping effect. In one specific embodiment, the flow groove depth, C may in a range of about 0.300 mm to about 0.500 mm, and more specifically in a range of about 0.340 mm to about 0.400 mm. The flow diameter, D may be in a range of about 0.700 mm to about 1.200 mm, and more particularly in a range of about 0.800 mm to about 1.165 mm. The effective length of the passage of the damping port 100 is approximately the distance where the actuating ball is generally tangent to the passage and also including a ±10% of the diameter that diverges from the most tangent point. The effective length is shown as a length, L in FIGS. 3 and 4C. In one embodiment, the effective length L may be in a range of about 15% to about 30% of the diameter of the actuating ball 54.

The area of each damping port 100 is generally proportional to the area of the flow diameter times the ratio, C/D. The area of the damping ports 100 is based, at least in part, on a fluid flow characteristic of a fluid such as, for example, automotive-type hydraulic brake fluid at a temperature of about −40 degrees C. In the embodiment shown in FIGS. 4A-4D, the flow of fluid is less restricted as it flows through the damping ports than flowing around the outer portion of the armature 48. This is in contrast to the prior art armature 148 which includes vent grooves 162, as will be discussed below. Thus, flow is directed through the damping ports 100 and restricted around the outer surface of the armature 48. In one embodiment, the outer surface of the armature 48 includes at least one section that is in close contact with the inner surface of the sleeve 50. The flow through the damping ports 100, therefore, exhibits the turbulent flow characteristic to provide improved damping response of the solenoid valve. The flow is also sufficient through the damping ports 100 to create turbulent flow at any of the typical viscous conditions, particularly those occurring in a vehicular brake system environment and at clod temperatures (i.e., −20 degrees C. or less).

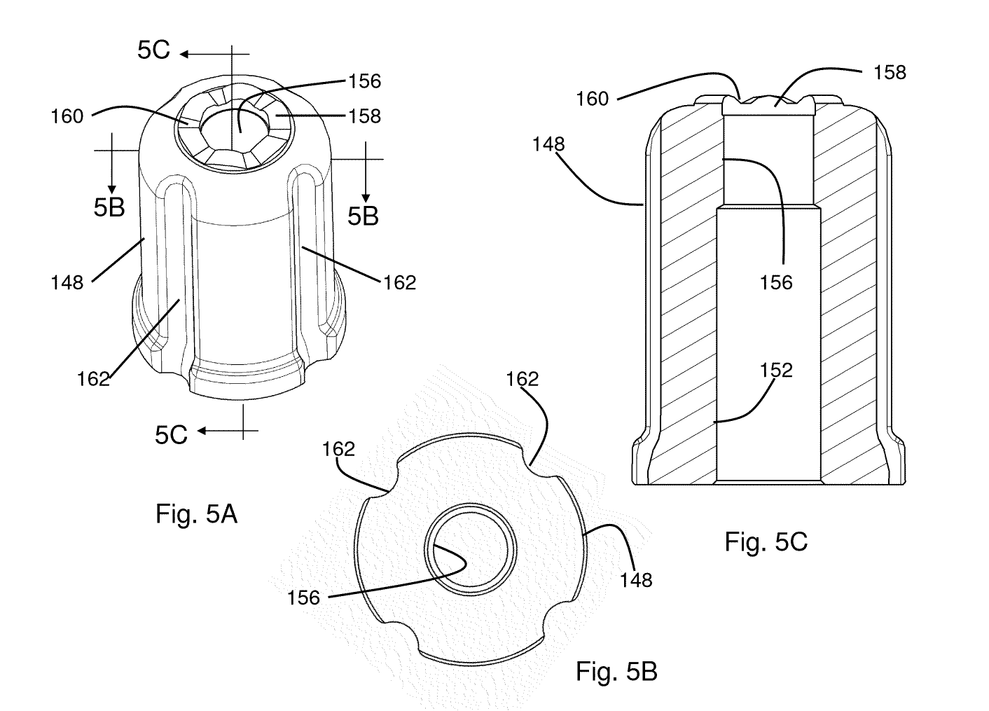

The fluid turbulence through the armature 48 has been found to dissipate more energy than prior art armatures, such as armature 148 of FIGS. 5A-5C, which are designed for generally laminar flow of fluids. While not wishing to be bound by theory, as fluid turbulence causes non-laminar flow of the liquid medium, there is an additional apparent shear stress created by eddies of fluid particles as the fluid shears through the damping port 100. This additional apparent shear stress, or turbulent shear, provides a damping characteristic that attenuates transient NVH excitations within the valve 30. In addition, the energy dissipation of turbulent flow is less dependent on fluid temperature and viscosity than laminar flow. As the turbulent fluid flow dampens undesirable movements within the valve 30, actuation and motion of the tappet 42 is smoothed out so that better control of the tappet nose relative to the valve seat is achieved. As such, better flow control of fluid, faster reaction times, and optimized brake system performance are realized.

Referring to FIGS. 5A-5C, the prior art armature 148 includes an end bore 156 that terminates in a stop ring 158. The stop ring 158 includes a plurality of reliefs 160 distributed around the perimeter of the end bore 156. The end bore 156 and stop ring 158 trap and hold an actuating ball (not shown) similar to actuating ball 54, described above. In contrast to the armature 48, the prior art armature 148 includes a plurality of fluid vent grooves 162 that provide sufficient volumetric flow of fluid to maintain laminar fluid flow around the armature 148 during axial movement events. Thus, as the armature 148 moves within the sleeve (similar to sleeve 50) of the solenoid valve, the fluid flow exhibits a laminar flow characteristic around the armature 148. As such, there is no substantial component of turbulent flow imparted to the fluid. Therefore, any damping associated with movement through the fluid is predominantly influenced by temperature and fluid viscosity. Thus, the vibration response of the solenoid valve changes more as the fluid temperature increases and the viscosity decreases.

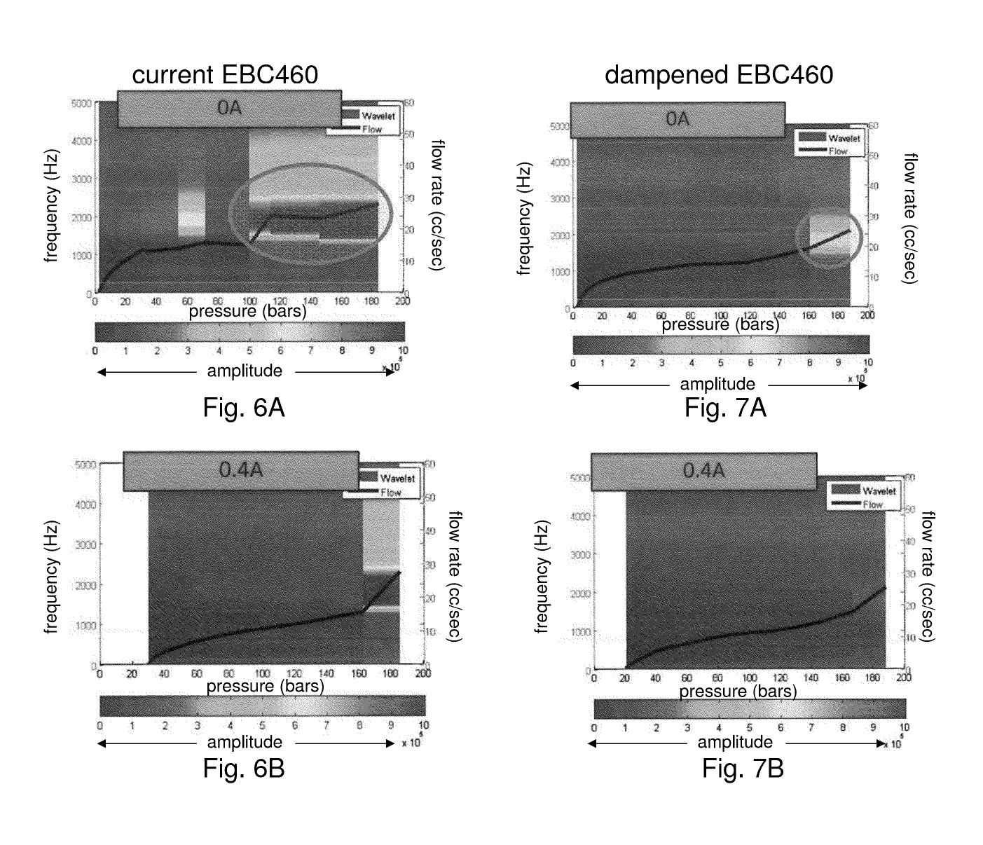

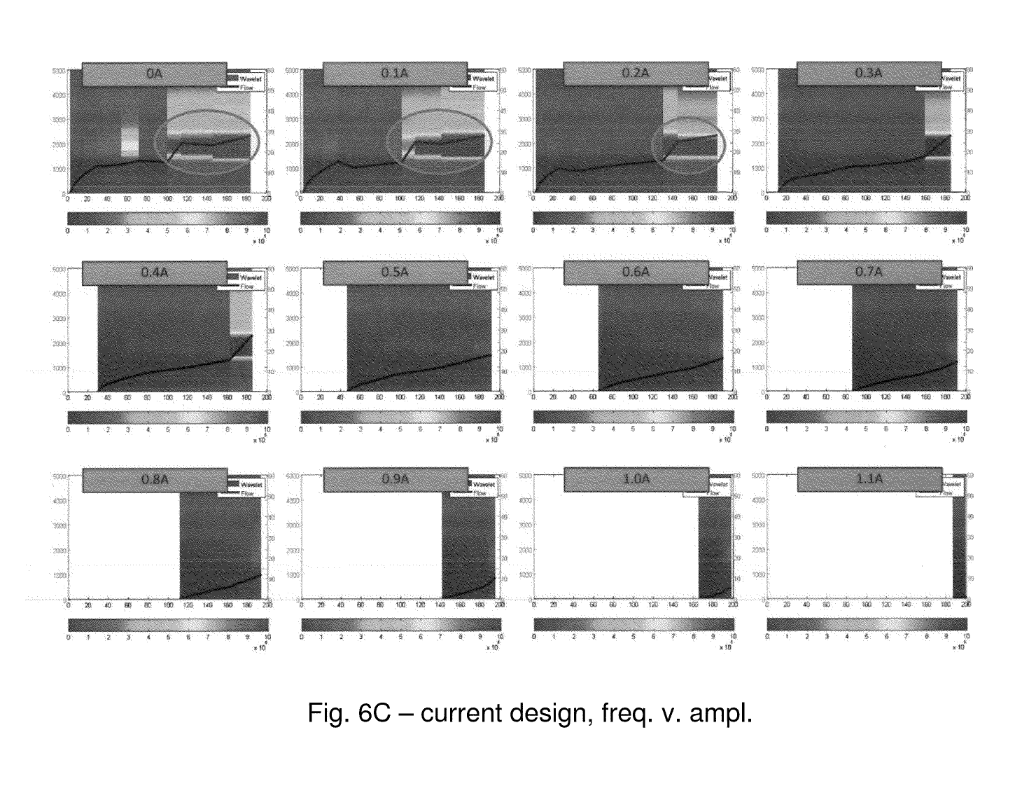

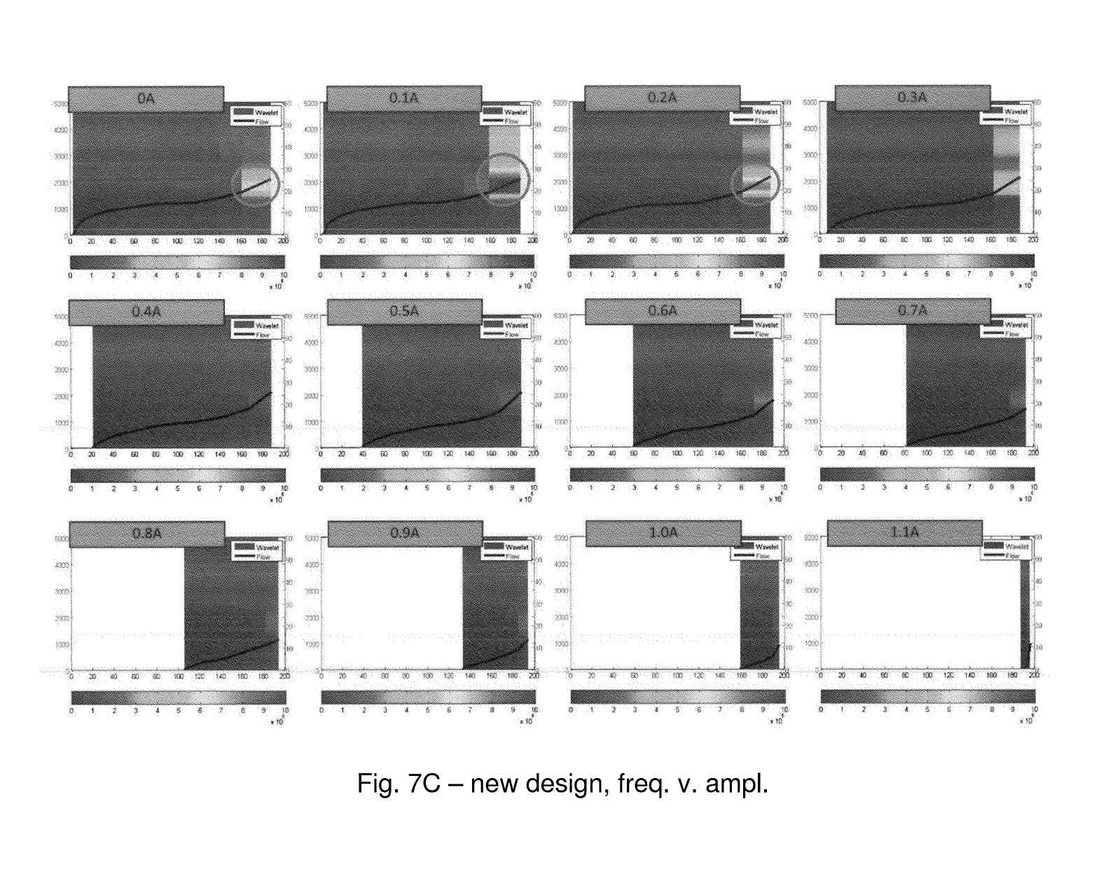

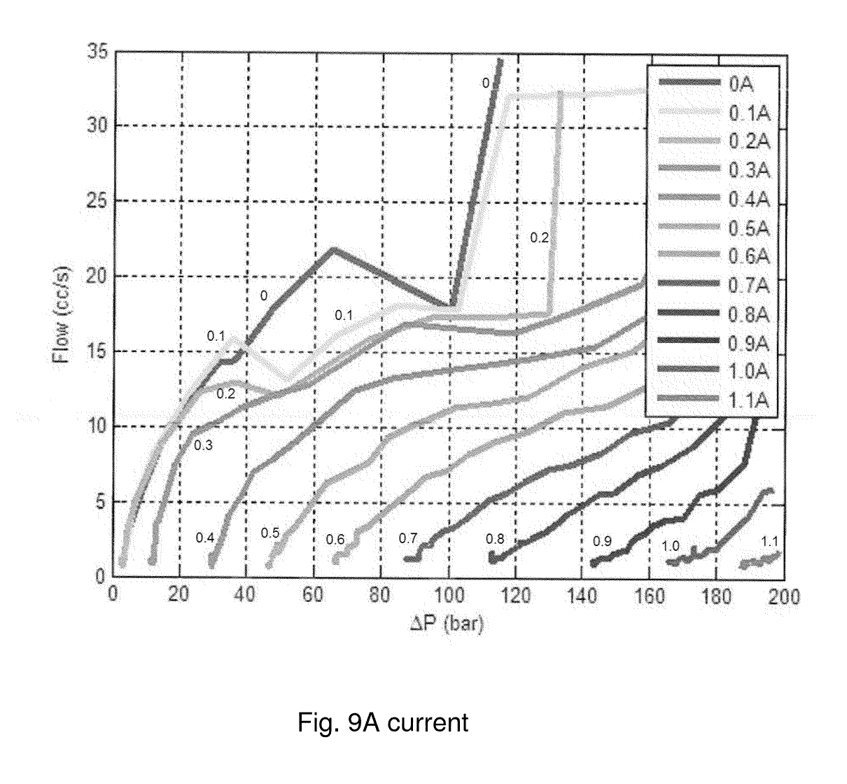

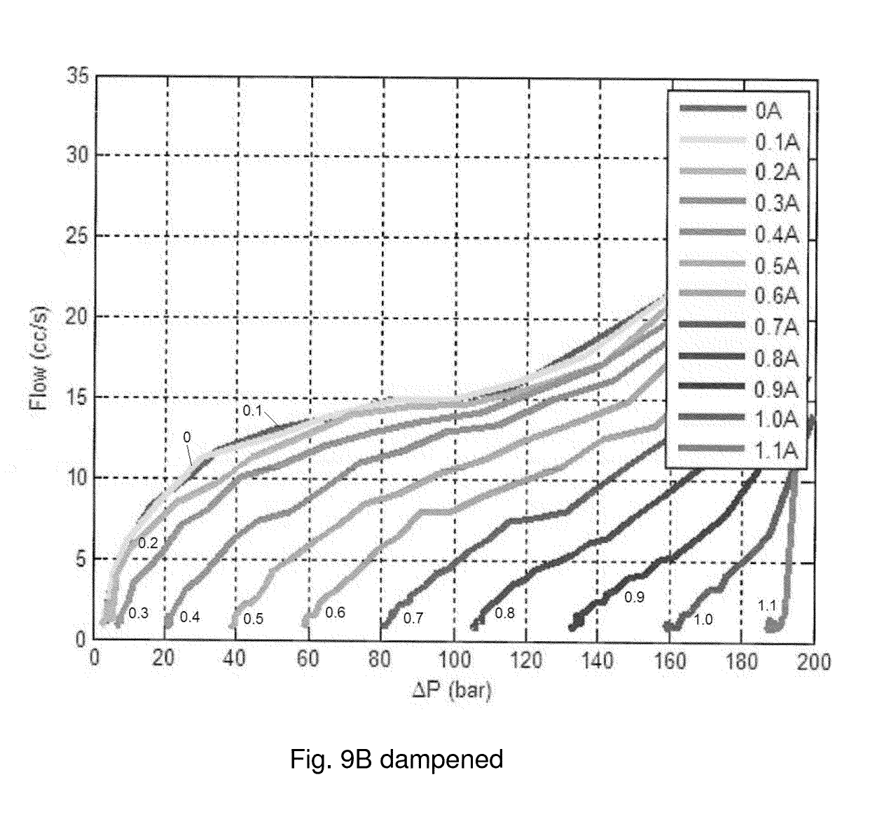

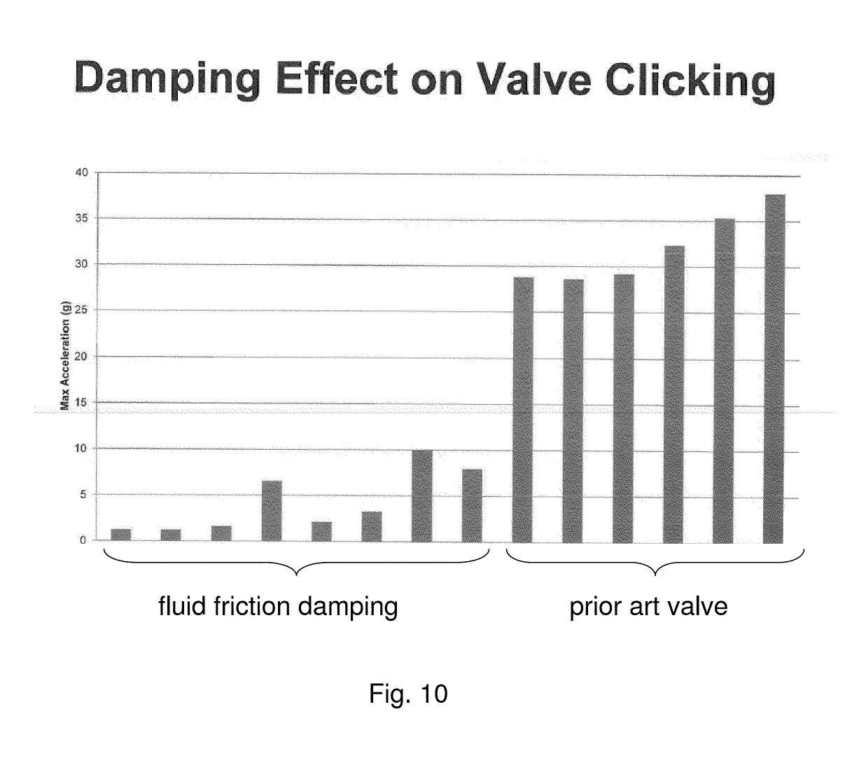

Referring now to FIGS. 6A-6C and 7A-7C, there are illustrated a series of performance response curves for a prior art solenoid valve having the prior art armature 148 and the solenoid valve 30 of the invention, respectively. FIGS. 6A, 6B and 7A, 7B are enlarged, selected response curves at a zero ampere coil power level and a 0.4 ampere coil power level. The curves show a vibration plot of frequency (left hand y-axis) vs. amplitude (shown in color, from blue [low] to red [high]) and a super imposed fluid flow plot of pressure (lower x-axis) vs. fluid flow rate (right hand y-axis). As can be seen from a comparison of the curves, the solenoid valve 30, which utilizes the turbulent flow damping structure and function of the invention, exhibits a lower vibration level across the high fluid flow range of the valve. This translates into smoother and quieter valve performance having reduced NVH signatures and a greater transparency of operation to the end user. As shown when comparing FIGS. 6C and 7C, as the coil amperage increases and flow rates increase in response to greater movement of the tappet, the flow rates of the solenoid valve 30 of the invention are higher (FIG. 7C) than the corresponding flow rates for the prior art valve. This condition is further validated by comparing the plots of pressure differential versus flow rate for the prior art valve, shown in FIG. 9A, and the solenoid valve 30, shown in FIG. 9B. As coil amperage increases, the flow performance of the damped solenoid valve 30 is improved over the prior art valve. FIG. 10 shows a comparison of the NVH performance of the solenoid valve 30 versus the prior art valve, corroborating the performance curves of FIGS. 6A-6C and 7A-7C.

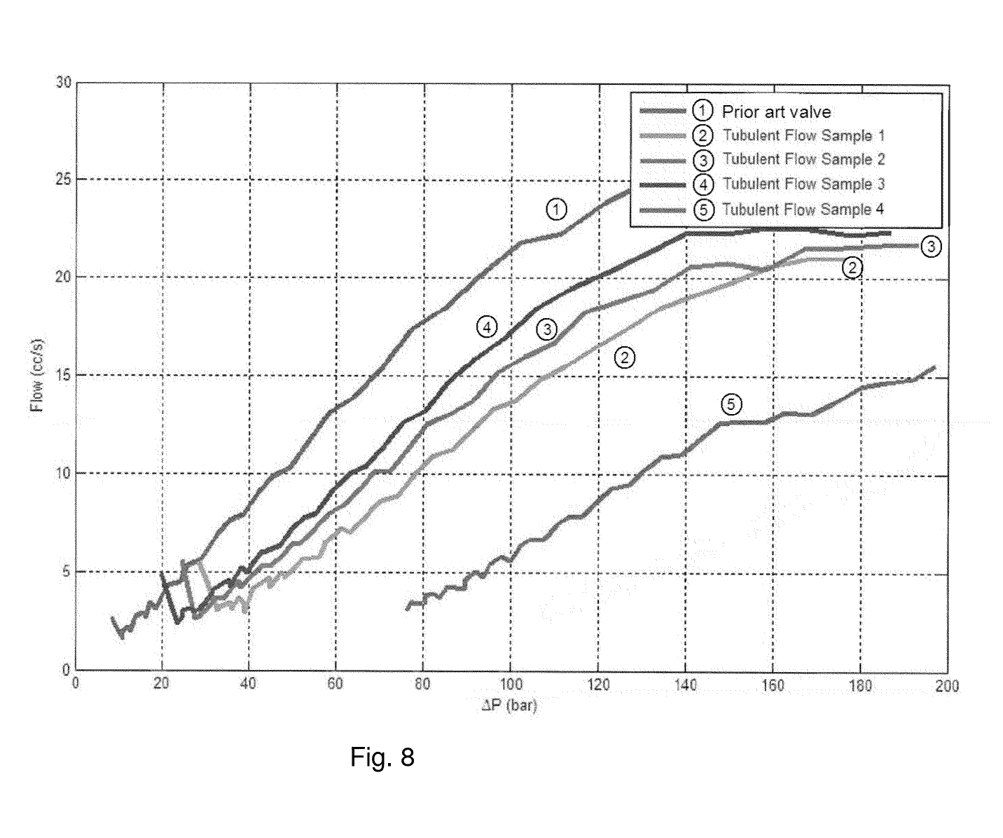

Referring now to FIG. 8, the performance of different embodiments of the solenoid valve 30 having different damping port x-sectional areas are shown. The damping port x-sections, as explained above, are defined by the damping port flow groove depth, C and the flow diameter, D. As the ports are sized to admit more laminar fluid flow and create less turbulence, the performance of the valves tends toward that of the prior art valve, shown as curve 1. For example, sample 1, shown at curve 2, creates less turbulent flow than sample 4, shown at curve 5. Thus, the effectiveness of the solenoid valve having damping ports can be tuned for different operating environments and NVH performance issues.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A solenoid valve comprising:
a valve body having a bore;
a tappet disposed in the bore and axially displaceable relative to the bore;
an armature connected to the tappet and configured to selectively axially displace the tappet, the armature having at least one damping port configured to create a turbulent fluid flow characteristic during axial displacement of the armature and tappet, the turbulent fluid flow characteristic providing a damping characteristic that attenuates a vibration component of the tappet.

2. The solenoid valve of claim 1 wherein the at least one damping port extends along an end bore of the armature, the at least one damping port defining a flow groove depth, a flow diameter and an effective length that create the turbulent flow characteristic.

3. The solenoid valve of claim 2 wherein an actuating ball connects the armature to the tappet, the at least one damping port is a pair of spaced-apart damping ports, each of the two damping ports having a ratio of the flow groove depth to the flow diameter in a range of about 35 percent to about 40 percent and the effective length of the damping port defined by the actuating ball.

4. The solenoid valve of claim 1 wherein the actuation motion of the armature moves the tappet to one of an opened and a closed condition and a spring returns the tappet to the other of the opened and closed condition, the vibration component being a function of the tappet movement prior to and at the one of the opened and closed condition.

5. The solenoid valve of claim 4 wherein the vibration component is an audible vibration component as the tappet is moved to the closed position against a valve seat of the valve body.

6. The solenoid valve of claim 3 wherein the effective length of the damping port is substantially a distance where the actuating ball is generally tangent to each damping port.

7. The solenoid valve of claim 7 wherein the effective length further includes about a 10 percent deviation of the actuating ball diameter that diverges from the most tangent point relative to the damping ports.

8. The solenoid valve of claim 2 wherein the flow groove depth, the flow diameter and the effective length of the at least one damping port are sized to produce the turbulent flow characteristic from a fluid having a viscosity range of about 800-1200 centistokes and flowing with a pressure and flow rate in a range of about 100-800 bar and about 50-300 cc/s respectively.

9. The solenoid valve of claim 8 wherein the at least one damping port is a pair of spaced-apart damping ports and the flow diameter defines a generally circular shape.

10. A solenoid valve comprising:
a valve body;
a sleeve connected to the valve body;
a tappet at least partially disposed in the valve body; and
an armature having a bore and an outer surface; a portion of the tappet being disposed in the armature bore, the armature bore being sized to permit fluid flow through the armature, the armature outer surface configured to provide a greater fluid flow restriction than fluid flow through the armature bore.

11. The solenoid valve of claim 10 wherein the fluid flow through the armature provides a damping characteristic to motion of the tappet.

12. The solenoid valve of claim 11 wherein the valve body includes a bore, the valve body bore having a spring seat, the tappet having a tappet shoulder, and a spring is disposed between the spring seat and the tappet shoulder, the spring generating a spring force in a first direction and the armature generating an actuating force in a second direction; and wherein the tappet motion is a generally axial motion and the damping characteristic is responsive to the axial motion of the tappet.

13. The solenoid valve of claim 11 wherein the armature includes at least one damping port that is configured to cause the fluid flow through the armature to have a turbulent fluid flow characteristic through the at least one damping port.

14. The solenoid valve of claim 13 wherein the at least one damping port has a flow groove depth and a flow diameter and wherein a ratio of the flow groove depth to flow diameter is in a range of about 30 percent to about 50 percent.

15. The solenoid valve of claim 14 wherein the armature includes an actuating ball and the at least one damping port cooperates with the actuating ball to define an effective passage length that is generally tangent to the actuating ball.

16. The solenoid valve of claim 14 wherein the effective passage length is in a range of about 15 percent to about 30 percent of a diameter of the actuating ball.

17. The solenoid valve of claim 14 wherein the flow groove depth, the flow diameter and the effective length of the at least one damping port are sized to produce the turbulent flow characteristic from a fluid having a viscosity range of about 800-1200 centistokes and flowing with a pressure and flow rate in a range of about 100-800 bar and about 50-300 cc/s respectively.

18. A hydraulic control unit of a vehicular braking system comprising:
a valve housing having a fluid conduit system;
a hydraulic pump in fluid communication with the fluid conduit system of the valve housing; and
a solenoid valve, the solenoid valve comprising:
a valve body;
a sleeve connected to the valve body;
a tappet at least partially disposed in the valve body; and
an armature having a bore and an outer surface; a portion of the tappet being disposed in the armature bore, the armature bore being sized to permit fluid flow through the armature, the armature outer surface configured to provide a greater fluid flow restriction than fluid flow through the armature bore.

19. The hydraulic control unit of claim 18 wherein the armature includes at least one damping port that permits the fluid flow through the armature, the at least one damping port defining a flow groove depth, a flow diameter and an effective length that create a damping characteristic of the tappet having a turbulent flow characteristic.

20. The hydraulic control unit of claim 19 wherein the armature includes an actuating ball connecting the tappet and the armature, the actuating ball further defining an effective passage length that is generally tangent to the actuating ball and is in a range of about 15 percent to about 30 percent of a diameter of the actuating ball, the at least one damping port having a ratio of the flow groove depth to the flow diameter in a range of about 35 percent to about 40 percent and the effective length of the damping port defined by the actuating ball.
